(19) United States
(12) Patent Application Publication
(10) Pub. No.: US 2003/0057401 A1
(43) Pub. Date: Mar. 27, 2003

(54) Inhibitor compositions

(76) Inventor: Steven Robert Craig, Aberdeen (GB)

Correspondence Address: David A. Jackson, KLAUBER & JACKSON, 4th Floor, 411 Hackensack Street, Hackensack, NJ, 07601, US

(21) Appl. No.: 10/151,728

(22) Filed: May 20, 2002

Related U.S. Application Data
(63) Continuation of application No. PCT/GB00/04414, filed on Nov. 20, 2000.

(30) Foreign Application Priority Data
Nov. 18, 1999 (GB) 9927315.3

(51) Int. Cl. C09K 3/00

(52) U.S. Cl. 252/387

(57) ABSTRACT

The invention relates to water-soluble corrosion inhibitor compositions, useful for inhibiting corrosion of an oil or gas pipeline. The compositions contain a corrosion inhibitor component and a binding agent component and may be applied to the internal surface of pipeline during or before their construction. When the pipeline is flooded with hydrotest fluid, the compositions dissolve over a period of time and inhibit internal corrosion of the pipe.

The invention relates to corrosion inhibitor compositions, and to methods for their application to newly constructed pipelines. The compositions of the invention may be applied to the internal surface of pipelines during construction or laying of the pipeline. When the pipeline is flooded, the corrosion inhibitor compositions dissolve over a period of time and inhibit corrosion of the pipe.

Various different techniques are used to lay pipelines. The method chosen will generally be the most economical. The cost of the pipelaying operation will vary depending upon factors such as the distance from land of the pipelaying site, and the proximity of the spooling station. The most costly part of the operation is generally the cost of operating a pipelay vessel; accordingly, most operators assemble as much pipeline as possible on land, particularly when the laying site is near the spooling station.

If the laying site is remote, assembly may take place on the pipelay vessel itself. The pipeline will be assembled in situ from fairly short sections of pipe. As the pipe is assembled, various checks for integrity, such as weld checks and stress checks, are made on the pipelay vessel. In less remote areas, the pipeline may be assembled by reeling of long sections of pre-assembled pipeline. In another alternative, a pre-assembled pipeline may be towed out to sea and sunk at the appropriate site.

A common feature of all these methods is that the assembled pipeline is flooded with a fluid during installation. This fluid is termed a hydrotest fluid and is almost always sea waler, for reasons of ease and economy. This allows the pipeline to be subjected to a pressure test prior to commissioning to check its integrity. The lag between installation and commissioning may on occasion only be a few days, but this period is generally longer and may be as long as a few years. During that time the hydrotest fluid must provide both leak detection capability and corrosion protection. The latter requirement is particularly important, since once corrosion has begun, the process is impossible to reverse, and the lifetime of the pipeline is significantly reduced as a result; if corrosion has started during the hydrotest, it will continue after the pipeline has been commissioned.

The current method of inhibiting corrosion in a newly-laid pipeline is to spike a corrosion inhibitor cocktail into the hydrotest fluid as it is injected into the assembled pipeline. Due to the difficulty of reliably introducing the required amount of inhibitor chemical into the hydrotest fluid, conventional methods are very costly in terms of vessel, equipment and manpower time. For example, it is very common for the pneumatic pumps on the pipelay vessel that inject inhibitor composition to become blocked. It is also common for the injection machinery that introduces the inhibitor chemical to freeze up, meaning that the inhibitor is not constantly applied to the hydrotest fluid. This increases the downtime of the pumping operation.

Furthermore, most of the pumps that are conventionally used in this operation inject a pulse of chemical into the sea water, meaning that the resulting concentration of inhibitor is not uniform along the length of the pipeline. Another problematic factor is that the volume of inhibitor chemical that is injected is not linked to the sea water flooding rate, so that the chemical concentration fluctuates in the hydrotest fluid as the flooding rate alters.

Often, the failure of the injection machinery is not noticed immediately, meaning that significant lengths of pipeline will contain no inhibitor chemical whatsoever in the hydrotest fluid.

It is thus difficult, if not impossible, for the installer or commissioner of the pipeline to guarantee that a homogenous concentration of inhibitor chemical has been introduced along the entire length of the pipeline in a concentration that is effective to inhibit corrosion for the desired length of time before the pipeline is commissioned. This is important, since if the concentration of inhibitor compound is too low at any point, it will not be effective. Furthermore, many compounds that are conventionally used as corrosion inhibitors are themselves corrosive above a certain concentration, meaning that high inhibitor concentrations are as undesirable as low concentrations.

Various techniques have been developed that attempt to reduce the time for which the pipelay vessel is required during the assembly of subsea pipelines. One such method is described in patent application GB 2303895, which describes an apparatus that is installed on the seabed and which is designed to flood a pipeline that is air or gas-filled. Sea water under regulated hydrostatic pressure enters the pipeline and urges a pig train along the pipeline at a controlled speed. The corrosion inhibitor chemical can be injected into the sea water as it enters the pipeline from a store in the apparatus. One problem with this method is that because the apparatus is installed on the seabed, the installer has no idea whether the introduction of inhibitor chemical into the hydrotest fluid was in fact successful. Furthermore, the hydrostatic head of pressure is not sufficient to push the pig train along the entire length of the pipeline. Booster pumps must be used to push the pig along the last 10% of the pipeline length.

A development of this method attempts to avoid the latter problem using a venting system that maintains air at one end of the pipeline at a pressure sufficiently below the ambient water pressure that thus creates a sufficiently large pressure differential ahead of the pig train such that the pig may be propelled along the entire length of the pipeline. However, this method does not in any way solve the primary problems of inhibitor chemical delivery that are referred to above.

There thus remains a great need for novel corrosion inhibitor composition and for methods of their application that allow the reliable delivery of a homogenous concentration of corrosion inhibitor to be attained along the entire length of a subsea pipeline.

### SUMMARY OF THE INVENTION

According to the present invention, there is provided a water-soluble corrosion inhibitor composition for inhibiting corrosion of a pipeline comprising a corrosion inhibitor component and a binding agent component.

The novel compositions of the invention allow the corrosion inhibitor chemical to be applied to component parts of a pipeline before its assembly and flooding. Once the pipeline is flooded, the active corrosion inhibitor chemical dissolves in the hydrotest fluid to give a final concentration that is effective to inhibit corrosion of the pipeline.

Preferably, the corrosion inhibitor compositions of the invention are suitable for inhibiting corrosion of a subsea pipeline, although target pipelines suitable for treatment according to the invention may also be overland or inter-country/continental pipelines.

By the term “binding agent component” is meant any compound or combination of compounds whose properties allow the composition to be applied enduringly to the internal surface of a pipe section. As applied to the interior of the pipe section, the composition must be sufficiently durable to withstand the influx of hydrotest fluid into the pipeline without being washed away from its point of application. This durability ensures that once hydrotest fluid has been introduced into the pipeline, an appropriate amount of dissolved inhibitor composition will be present at a concentration that is effective to inhibit corrosion.

In one aspect of the invention, the composition contains a binding component that allows it to be coated to the internal surface of a pipe section. In this aspect, the composition may be sprayed or painted onto the interior of a pipe section before its assembly, to dry as a durable coating. When the assembled pipeline is flooded, the hydrotest fluid enters the pipeline from one end until the whole length of the pipeline is flooded. At this point, the coating begins to dissolve in the hydrotest fluid, reaching a final concentration in the static fluid that is effective to inhibit corrosion.

Suitable binding components in this aspect of the invention include one or more curing agents that allow the composition to dry as a coating over a certain period of time, yet which upon contact with hydrotest fluid, will dissolve back into solution. The binding agent may comprise between 5 and 95% of the total wet weight of the composition.

Suitable curing agents will be clear to those of skill in the art and include curing agents such as polyacrylamide, polyvinyl alcohol, and fish glue (Select Industries, Wichita Falls, Tex.).

For polyacrylamide, the molecular weight of the polymer used should preferably range between 250,000 and 1,000,000, to ensure that the dissolution rate in sea water is slow (circa 5-10 days). Upon contact with water, the surface of this polymer forms a hydrated polymer barrier and slows down the dissolution process. Polyacrylamide may comprise between 5 and 95% of the total wet weight of the composition, preferably between 30 and 90%, more preferably between 50 and 90% wet weight. In a particularly preferred embodiment of this aspect of the invention, polyacrylamide is used at a proportion of around 90% wet weight. Corrosion inhibitor compositions that comprise this amount of binding agent dissolve only slowly and are thus particularly useful to prevent chemical wash-out when there are pipelines of such great length that in order to fill with sea water, they need to free-flood for periods as long as between 1 and 5 days.

Fish glue is composed of gelatine, phenol and water. This compound is typically used in a proportion of between 5 and 95% wet weight, preferably between 30 and 90%, more preferably between 50 and 90% wet weight.

Poly vinyl alcohol composition is also typically used in a proportion of between 5 and 90% wet weight. This material may be used to provide a level of flexibility for the final cured form of the composition. Poly vinyl alcohol has a slow solubility rate and therefore increasing its concentration in the corrosion inhibitor composition proportionately increases the length of time taken for the dried composition to dissolve in the hydrotest fluid. In addition to poly vinyl alcohol, small amounts of ammonia solution and 2-chlorobuta-1,3-diene are included in the poly vinyl alcohol composition, to stabilise the emulsion of the liquid product and improve drying characteristics.

In another preferred embodiment of this aspect of the invention, fish glue (around 50% wet weight) and poly vinyl alcohol composition (around 40% wet weight) together form the binding agent component of the composition.

An amount of curing agent will typically be used that causes the composition, when applied to a section of pipe as a thin coating, to dry to a non-tacky consistency over a period of between 1 and 48 hours, preferably between 1 and 24 hours, more preferably between 1 and 12 hours under normal atmospheric conditions. As the skilled reader will appreciate, ambient atmospheric conditions vary greatly between the various regions of the world, in terms of temperature, humidity, and normal wind turbulence. However, the fine-tuning of the appropriate level of curing agent will be well within the abilities of the skilled reader. In some circumstances, for example, during cold, humid or wet conditions, an air supply may be blown through the pipe sections to which the compositions of the invention have been applied to lessen the drying time.

In its dried form, the compositions of this aspect of the invention should form a thin coating that covers the internal surface of the pipe. Typically, the thickness of the coating will be less than 1 mm, preferably less than 0.5 mm, more preferably 0.2 mm or less. At this thickness, it will still be possible for pigs to pass along the pipeline without their passage becoming blocked.

The fact that the coating is thin enough to allow pigs to pass along the pipeline is particularly advantageous, since pigs are used in most installation methods to ensure that the pipeline is filled with hydrotest fluid to greater than 99% of its volume. Pigs are also used to check the pipeline for buckles and inconsistencies. To aid passage of pigs, the dried coating composition should be free of inconsistencies such as ripples and undulations.

The dried coating should also form a coating that is tough enough to prevent the composition from being scraped off the internal walls of the pipeline as pigs pass along it. This would provide an obvious drawback, since after flooding, an area of the pipeline where the composition had been scraped from the internal wall might not then contain an effective concentration of corrosion inhibitor. Furthermore, scraped inhibitor compound would block the pig's progress.

Another advantage of the coating compositions of this aspect of the invention is that internal crawlers (that are used to check the integrity of welds that join segments of the pipe together) are not prevented from moving along the inside of the pipe. The wheels of the crawlers can easily pass unheeded over the non-tacky, thin, coating layer.

It will be necessary for the compositions of this aspect of the invention to possess a degree of flexibility when dried. For example, in methods of laying pipelines such as reeling, sections of flexible pipeline are rolled onto a reel. Under these flexed conditions, the dried coating composition as applied to the internal surface of the pipeline must not crack or peel from the pipeline interior. To impart the required degree of flexibility to the dried coating composition, a plasticiser may be used. However, some binding agents such as polyvinyl alcohol may already possess the desired degree of plasticity.

Suitable plasticisers include poly vinyl alcohol, monoethylene glycol and glycerine. Other examples will be clear to those of skill in the art.

The plasticiser will typically be present in the corrosion inhibitor composition as a proportion of between 1 and 60%, preferably between 11 and 50%, more preferably between 1 and 5% wet weight. As the skilled reader will be aware, certain of the binding agents discussed above impart properties of flexibility to compositions in which they are contained (for example, poly vinyl alcohol). If such a binding agent is used, it may not be necessary to add a separate plasticiser.

The compositions of this aspect of the invention may be applied using a number of different techniques, as will be clear to the skilled reader. In the simplest method, the compositions may be painted onto the internal surface of a pipe section. A more convenient method may be by spraying. Composition may be applied to areas of the pipe section that are not accessible from either end of a section using more complicated delivery means such as spraying apparatus mounted on wheels or rollers that can travel along the pipe interior. Another method involves the use of two or more pigs, between which a quantity of coating composition is sandwiched. The pigs are propelled along the interior of a pipe section by compressed air, and as they travel along the pipe, the composition coats the pipe interior.

In a second embodiment of the invention, the composition may take the form of a gel. In this embodiment, the binding component thus comprises a gelling agent, such as, for example, monoethylene glycol. Other examples include water, triethylene glycol, diethylene glycol and methanol.

The compositions of this aspect of the invention thus take the form of a gel whose physical properties are such that, once applied to the internal surface of a pipe segment, the gel cannot be easily removed. The gel composition will thus be able to withstand the significant forces of turbulence resulting from the rapid passage of hydrotest fluid passing through the pipeline during the initial flooding procedure. After the flooding process has completed, an appropriate concentration of corrosion inhibitor composition will thus be present at each of its points of application to generate a concentration of corrosion inhibitor that is above the minimum effective inhibitor concentration.

The compositions of this aspect of the invention may be thixotropic. In this aspect, the gelling agent will thus be present in the composition in proportions that impart thixotropic properties to the composition. By “thixotropic” is meant that the fluid possesses non-Newtonian fluid properties, commonly described as shear thinning or pseudo-plastic behaviour, and exhibits a reversible decrease in viscosity with increasing shear rate. Shear thinning results from the tendency of the applied force to disturb the long chains of the component molecules of the fluid from their favoured equilibrium conformation, causing elongation in the direction of the shear.

These compositions are of particular use in methods of laying pipeline where long sections of pre-assembled pipe sections are used (such as reeling methods). In these methods, there is no need for internal crawlers to be used to check for weld integrity or stress faults, so the presence of obstructing gel compositions inside the pipeline does not interfere in any way with the pipelaying procedure.

The compositions of this aspect of the invention may be applied to the internal surface of a pipe as amorphous gels. An important advantage of applying a corrosion inhibitor in such a physical form is that the composition sticks to the internal surface of the pipe at any angle, even when applied to the top internal surface of the pipe. This means that during the assembly process, there is no need to orientate the pipe sections to ensure that the gel composition is on the bottom surface of the pipe. Furthermore, it means that as the angle of slope of the pipeline increases as the pipeline extends from the pipe-laying vessel down to the seabed, the composition maintains the same position in the pipe. This means that the composition does not gather at the bottom of bends or slopes in the pipe that form during installation or as it lies on the sea floor. This ensures that when the pipeline is flooded with hydrotest fluid, the final concentration of corrosion inhibitor reaches that which was intended.

The binding agent used in this aspect of the invention will typically include a gelling agent incorporated within a mother liquor. Suitable gelling agents include highly-substituted hydroxypropyl guar (MS 1,2), carboxymethyl-hydroxypropyl guar or carboxymethyl guar, succinoglycan, standard xanthan gum and guar gum. As the skilled reader will appreciate, many other materials are suitable as gelling agents that function to viscosify a liquid or create a gel.

The proportion of gelling agent present in the composition will typically range between 0 and around 10%.

The second component of the binding agent present in the compositions of the second aspect of the invention is the mother liquor. A number of materials may be used as the mother liquor, although it is essential that this component is soluble in the hydrotest fluid. Particularly suitable materials include monoethylene glycol, water, diethylene glycol, triethylene glycol and methanol. Monoethylene glycol is preferred.

The proportion of this component may range between 50 and 95% wet weight and is typically between 70 and 90%.

In an alternative embodiment of this aspect of the invention, the gel compositions may be formed by cross-linking one or more of the gel components together to create the desired consistency by forming high molecular weight globules within the gel structure, so decreasing its solubility. For example, two or more components may be manifolded together in a hose or pipe. Cross-linking may occur naturally as a consequence of the inherent properties of the gel components, or a specific cross-linking agent may be used, such as Borax or sodium hydroxide.

As discussed above for the compositions of the first aspect of the invention, the compositions of the second aspect may contain one or more curing agents, and/or plasticisers.

The compositions of this aspect of the invention may be applied by any suitable means, which will be clear to the skilled reader. One convenient method for applying the gel composition to a pipe interior is using a stiff hose that can be extended into the interior of a pipe section. Gel composition can then be extruded through the hose in the appropriate quantity.

In a third embodiment of the invention, the corrosion inhibitor may take the form of a gel enclosed within a water-soluble bag that may be attached to the internal wall of a pipeline. Suitable water-soluble bags are available in the art and include those produced by Champion Technologies in any size required and will dissolve in cold seawater within a period of between one and twenty-four hours. Of course, the dissolution rate of the bag can be increased by doubling the thickness of the bag and so on. The size of the bags may be designed according to the volume of gelled treatment chemical required at each end of the individual pipeline sections. The bags may be attached to the pipeline wall using a water-soluble glue, such as that manufactured by Champion Technologies under the name Aquabond II. This adhesive dries to a flexible consistency within a six to eight hour period, and begins to dissolve within a three hour period on contact with water.

The corrosion inhibitor component to be included in the compositions of the above-described aspects of the invention may be selected from a wide range of compounds that are known in the art to possess the required properties. Preferably, a cocktail of corrosion inhibitors is used, the individual components of which possess complementary inhibitory properties, both with respect to the type of pipeline material that is being protected and the ion content of the sea water itself. Other factors that influence the choice of corrosion inhibitor package are environmental concerns; these will vary throughout the various regions of the world. For example, in the North sea the British, Dutch, Norwegian and Danish oilfield sectors all use different chemical inhibitor packages that fit their environmental regulations.

A particularly preferable inhibitor cocktail is that sold by Champion Technologies Inc., under the formula name O-3670-R. This inhibitor cocktail has an extensive national and international track record. This product is also preferred as it is a single fluid package, and therefore improves handling. Furthermore, the need for applying two or three fluid packages separately is eliminated. Component biocides and oxygen scavengers of other inhibitor cocktails will neutralise each other if not applied correctly.

Examples of suitable corrosion inhibitor components include phosphate esters, imadazoline salts and quaternary amines, such as quaternary ammonium amines.

In the compositions of the invention, the amount of corrosion inhibitor concentration used may be varied to suit the particular requirements of the system. For example, if the lag between flooding and commissioning of a pipeline is only to be a few days or weeks, then only a low concentration of inhibitor chemical will be required. If, however, the pipeline is to be left unused for months or years, then a higher ambient concentration of inhibitor chemical will be necessary in the flooded pipeline, meaning that a higher concentration of inhibitor agent must be used.

Typically, the proportion of corrosion inhibitor in the composition is between 1 and 25%, preferably between 5 and 20% more preferably between 8 and 12%, most preferably around 10%.

The concentration of corrosion inhibitor that eventually dissolves in the hydrotest fluid should be at least 350 ppm. It should be emphasised that this value represents the concentration of the corrosion inhibitor present in the composition itself. Accordingly, if the corrosion inhibitor is present in the composition at 10%, 3500 ppm composition should be used. This will be clear to the skilled reader.

The amounts of composition applied to the pipeline segments may be varied depending on the proximity of the pipeline segment to the opening at which the hydrotest fluid enters the pipeline (the proximal end). For example, it may that a composition is to be used which dissolves in sea water over a period of 12 hours. If it will take 4 hours for the pipeline to fill completely, then a larger amount of composition must be applied to the segments at the proximal end where the hydrotest fluid enters first. This will ensure that a homogenous concentration of inhibitor compound is present throughout the pipeline. Of course, it must also be appreciated that when using hydrostatic head of pressure to flood a pipeline using sea water as the hydrotest fluid, the initial entry of fluid will be the most rapid; as the hydrostatic head of pressure decreases, so the rate of fluid entry will decrease. A greater amount of chemical will therefore be washed off the internal surface of the pipeline at its proximal end.

The concentration of corrosion inhibitor present in the composition itself should not exceed around 50,000 ppm in the compositions of the invention, since at this concentration, the inhibitor component is itself corrosive. Use of a corrosion inhibitor at this concentration might therefore corrode the pipeline in the period before it is flooded.

Pipelines generally range in diameter between 3 inches and 50 inches. As the skilled reader will appreciate, it is simple to calculate the volume of sea water needed to flood a pipeline and thereby calculate how much corrosion inhibitor is needed.

A biocide may also be included in the corrosion inhibitor package. Preferred biocides are those that are stable in the presence of an oxygen scavenger. Suitable biocides include glutaraldehyde, formaldehyde, myacide, n-alkyl dimethyl ammonia chloride (this biocide has an unlimited number of forms as the alkyl group provides a site to attach a large range of chemistry types), cocodiamine hydroxy acetate, tetrakis (hydroxymethyl) phosphonium sulphate, quaternary ammonium chlorides and polymeric biguanide hydrochloride.

An oxygen scavenger may also be included in the inhibitor package. Suitable chemicals include sodium bisulphite, ammonium bisulphite and hydrazine. In addition, sodium metabisulphite can also be used. This chemical is a solid and becomes an oxygen scavenger only when dissolved in water, as it produces sodium bisulphite in this form.

The compositions of the above-described aspects of the invention dissolve in hydrotest fluid at a controlled speed. This may be an inherent property of the composition, derived from the properties of the binding agent component. Alternatively, an additional agent may be included in the composition that is effective to control the speed of dissolution of the composition into hydrotest fluid. Such a compound is herein referred to as a dissolution agent.

The speed of dissolution in hydrotest fluid must be slow enough to limit dissolution to a minimal level during the initial period of influx of the hydrotest fluid into the pipeline. As discussed above, the amount of inhibitor composition left remaining after the flooding event must be sufficient that the final concentration of dissolved inhibitor in the hydrotest fluid contained within the pipeline is above the minimum effective inhibitor concentration across the entire length of the pipeline.

Depending on the length of the pipeline being flooded, the flooding procedure may be achieved in as short a time as one hour or less, or may take as long as 5 days. The dissolution speed of the composition should therefore be designed so as to reflect the particular requirements of the system. It may also be that varying dissolution speeds are required at different points along the pipeline. For example, a very slow speed of dissolution may be required at the end where the hydrotest fluid (sea water) enters, whilst a higher speed of dissolution may be acceptable at the distal end of the pipeline where the hydrotest fluid enters last.

A particularly suitable dissolution agent is polyacrylamide. As the skilled reader will be aware, certain plasticisers are effective in controlling the speed of dissolution of a composition in which they form a part. It may thus be that it is not necessary to include both a plasticiser and a dissolution agent in the compositions of the invention.

The dissolution agent will typically be present in the corrosion inhibitor composition as a proportion of between 1 and 50%, preferably between 2 and 20%, more preferably between 5 and 10% total wet weight.

Typically, the compositions of the invention dissolve at a rate of between 0.01 ppm/min and 100 ppm/min in static sea water, preferably at between 0.01 ppm/min and 20 ppm/min, more preferably at between 0.5 ppm/min and 10 ppm/min. As the skilled reader will appreciate, depending on their diameter, pipelines are generally flooded with sea water at a rate of around 0.5 m pipe length per second. At this rate of flooding, the contact time for composition and sea water is very low, meaning that the compositions of the invention will diffuse at a faster rate than normal. The ambient pressure will also affect the dissolution rate. These factors must be taken into account when designing a suitable composition for use under these conditions.

Many additional components may be included in the compositions of the invention, according to the individual requirements of each system. For example, scale inhibitors are sometimes required to be present within a “corrosion inhibitor package”. These types of products use polyacrylates and phosphonate chemistries, for example, phosphonates, acrylic co/ter-polymers, polyacrylic acid (PAA), phosphino carboxylic acid (PPCA), phosphate esters, or other traditional aqueous-based scale inhibitor chemistries. The concentration of scale inhibitor as incorporated in the compositions of the invention is in the order of about 1-5% by weight.

Demulsifiers may also be included within the compositions of the invention. These products are propylene oxide/ethylene oxide co-polymers and resin formulations. They are hydrophilic molecules that attach onto water molecules, which are emulsified in oil, and cause the water to sink to the bottom. These products may be incorporated into the composition in the event that there should be concern about the oil production emulsifying the water residue upon start-up, causing a top-side process problem.

Anti-foams may also be incorporated into the compositions of the invention, as some corrosion inhibitors and biocides tend to stabilise foams, due to their surfactant nature. Anti-foams eliminate this tendency. Such compounds are generally polyglycol-based chemistries, and should be present in proportions of around 0.5% wet weight of the composition.

Wax inhibitors may also be added to the compositions of the invention, as this helps to prevent the build up of wax on the pipe wall. This is a particular problem for certain crude oil types. Wax inhibitors are polymeric-based and generally incorporate an n-alkane backbone and can incorporate PEG ester groups. If included, wax inhibitors should be present in a proportion of around 5-10% wet weight of the composition.

A leak detection dye can be added to the compositions of the invention. Such a dye can be included in the composition in a known amount, such that when dissolved in the hydrotest fluid, the dye will be present at a pre-determined concentration that can be calculated with knowledge of the pipe dimensions. Any fluctuations in the concentration of the leak detection dye will thus reflect the presence of leaks or breaches in the integrity of the pipeline. If included, a leak detection dye should be incorporated into the formulation in the range of between 0.1 and 5%, preferably around 0.7-1.0% wet weight of the composition. The industry standard dye is the sodium salt of fluorescein (C20H1205.2Na). An alternative dye product that can be used is an optical brightening agent (Champion Cleardye) which is detected only under ultraviolet light. .

All the above components of the compositions of the invention must, of course, be compatible with each other. By “compatible” is meant that each component is non-reactive with any of the other components at the concentrations at which each component is present and under the conditions at which the compositions are stored and used.

According to a further aspect of the invention there is provided a corrosion inhibitor composition containing the following components: polyacrylamide (250,000-1,000,000 Mw polymer), 90%; corrosion inhibitor, 10%. Preferably, the corrosion inhibitor is O-3670-R (Champion Technologies.).

According to a still further aspect of the invention there is provided a corrosion inhibitor composition containing the following components: fish glue, 50%; polyvinyl alcohol, 40%; corrosion inhibitor, 10%. Preferably, the corrosion inhibitor is O-3670-R.

According to a still further aspect of the invention there is provided a corrosion inhibitor composition containing the following components: highly-substituted hydroxypropyl guar (MS 1,2), 2.25%; monoethylene glycol, 87.75%; corrosion inhibitor, 10%. Preferably, the corrosion inhibitor is O-3670-R.

According to a still further aspect of the invention there is provided the use of the compositions of the above-described aspects of the invention as corrosion inhibitors in a pipeline, preferably in a subsea pipeline.

The invention also provides a pipe section to which a corrosion inhibitor composition as described above has been applied. The invention also provides a pipeline, such as, for example, a subsea pipeline, comprising a plurality of pipe sections treated with the corrosion inhibitor compositions of the invention.

It is not essential that all of the sections of a pipeline are treated by the compositions of the invention. The incidence or frequency at which treated and untreated sections are used in the pipeline as a whole will depend upon factors such as the length of each pipe segment, the amount of composition which is applied to each treated pipe segment and the type of corrosion inhibitor composition that is applied to the pipeline.

Homogenous concentrations of corrosion inhibitor concentration will be more easily attainable if the inhibitor is applied in small amounts at regular intervals along the pipeline length. For example, for short pipe segments of between 10 and 50 m, the simplest way to ensure that a homogenous concentration of inhibitor chemical is achieved in the pipeline may be to apply the composition to every section of pipe. In this way, there can be no errors in the pipelaying procedure that will detract from the intended efficacy of the operation. For example, if an operator must use one treated pipe segment in every 10 untreated segments, this may cause some confusion at the assembly site. Furthermore, without constant monitoring of the assembly process (which involves extra expense), the commissioner of the pipeline can never be sure that the pipeline has been assembled in the correct manner.

In methods of pipelaying such as reeling, where long sections of pipe are assembled together, there may be problems associated with applying the compositions of the invention to the interior of each pipe section. In this instance, composition may conveniently applied to the pipe sections near each end, by “spotting” the compositions onto the interior of the pipe section. Despite the considerable length of pipe section that contains no applied inhibitor compositions, it has been found that it is still possible to attain a near-homogenous concentration of inhibitor at concentrations that are effective to inhibit corrosion.

Typically, corrosion inhibitor composition is applied at intervals of at least every 200 meters, preferably 100 meters or less, more preferably 25 meters or less.

According to a further aspect of the invention, there is provided a method for inhibiting corrosion of a sub-sea pipeline comprising applying a water-soluble corrosion inhibitor composition to the internal surface of a component section of said pipeline. As stated above, the method of application of the composition will depend upon which composition type is used, and the individual requirements of each system.

For example, the corrosion inhibitor composition of the first aspect of the invention may conveniently be sprayed or painted onto the internal surface of a component segment of the pipeline, or applied using pigs that are urged along the pipeline using compressed air or compressed water. The corrosion inhibitor composition of the second aspect of the invention may conveniently be applied as a thixotropic gel.

Various aspects and embodiments of the invention will now be described in more detail by way of example. It will be appreciated that modification of detail may be made without departing from the scope of the invention.

### EXAMPLES

The following data relates to the chemical treatment of sea water by Champion O-3670R which has been deployed into a pipeline.

Champion O-3670R is a cocktail product which contains an oxygen scavenger (to prevent oxygen corrosion) and a biocide/corrosion inhibitor component (to prevent microbiological induced corrosion {MIC} and act as a corrosion inhibitor on the steel).

### Example 1

### Oxygen Scavenging Performance

Champion O-3670R utilises standard oxygen scavenging chemistry to remove dissolved oxygen from seawater. Tests have shown that this material when injected at 350 ppm will provide the following oxygen removal performance.

| | | | | | |
|---|---|---|---|---|---|
| | | | Initial | | Time to |
| | | | Dissolved | Time to Scavenge | scavenge to |
| | | | Oxygen | to 0.4 mg/L | 10 ppb Dissolved |
| Product | Medium | Dosage | mg/L | Dissolved Oxygen | Oxygen |

| | | | | | |
|---|---|---|---|---|---|
| Champion O-3670R | Seawater | 350 ppm (min) | 9.5 | 8 minutes | 48 minutes |

These data show that Champion O-3670R when dosed in seawater at 350 ppm will effectively reduce dissolved oxygen content to less than 10 ppb in approximately one hour.

### Example 2

### Corrosion Inhibition Performance

The corrosion inhibition component of Champion O-3670R is water-soluble amine. This component has been tested at both Champion Technologies Research and Development base in Houston and by the European Technical Group in Aberdeen.

Test I Rotating Cylinder Electrode (RCE) Bubble Test

| | |
|---|---|
| Temperature | 65° C. |
| Continuous CO₂ sparge | at one bar |
| Pressure | Ambient |
| Electrode Speed | 3 ft per second |
| Dosage | See Below |

The following test results are for the inhibitor component dosed at only ⅓ of the amount of the component that is contained in Champion O-3670R and that are in fact released into the seawater

A typical rate of free-flooding is between 0.5-1.5 ft per second. Therefore, the test conditions above may represent a more severe environment relative to potential corrosion mechanisms.

Initial Corrosion Rate=100.0 mpy(milli inches per year)

Corrosion Rate after 17 hours=5.7 milli-inches per year (mpy)

It is expected that the corrosion rate at the test temperatures will be greater than the actual rate under field temperature (expected to be approximately 5° C.).

In essence, the reaction rate should decline by a factor of 1.414 for every 10° C. drop in temperature. Thus, a temperature drop from 65° C. (test) to 5° C. (field) could represent a 5.6× reduction in the reaction rate.

Provided that this relationship holds, the corrosion rate will be approximately 1 mpy.

Test 2 Static Corrosion Coupon Tests

Champion O-3670R was tested at a dosage of 375 ppmv (volume). The higher dosage allowed for the incorporation of 25 ppmv tracer dye in the formulation.

| | Dosage | Initial Weight | Final Weight | Corrosion |
|---|---|---|---|---|
| Chemical | ppmv | ppmv | ppmv | Rate mpy |
| Champion O-3670R | 375 | 12.4577 | 12.4460 | 1.47 |
| (Dyed) | | | | |
| | 375 | 12.1393 | 12.1273 | 1.51 |

Average corrosion rate for Champion O-3670R (Dyed) was 1.49 mpy in this test. This test was conducted at ambient temperature and pressure using a synthetic sea water.

Under the conditions of these tests and considering the temperature and flow rate in the field, these tests infer that the corrosion inhibitor component in Champion O-3670R will provide sufficient corrosion inhibition for a 6 month shut in period when dosed at 350 ppm.

### Example 3

### Biocide Performance

Champion O-3670R contains a biocide component that has a demonstrable effectiveness against Sulphate Reducing Bacteria (SRB). Tests have been carried out to document this component's performance as a broad spectrum biocide against both planktonic and sessile SRB strains.

3.1 Planktonic Strains

Test Conditions

| | |
|---|---|
| Sea Water: | North Sea sample |
| Treatment with Champion | At dosages from 50-500 ppmv and Blanks |
| O-3670R: | |
| Serial Dilution Incubation: | First analysis after 20 days at 5° C. |
| | Second analysis after a further 4 days at |
| | 37° C. |
| | Third analysis after a further 16 days at |
| | 37° C. |

Results

| | | Champion O-3670R |
|---|---|---|
| Time | Blanks | Treated |
| At 20 days | No growth | No growth |
| At 24 days | +ve SRB | No growth |
| At 40 days | +ve SRB | No growth |

These results show that even at a dosage of 50 ppm Champion O-3670R is effective against planktonic SRB.

3.2 Sessile

The purpose of killing planktonic SRB is to prevent the formation of sessile SRB colonies. A series of tests has been conducted in which viable sessile cultures have been treated with a range of biocides.

As a comparison, these extracted results demonstrate the performance of the biocide component in Champion O-3670R (BACTRON KK17 and KK-27). These results can be compared to those for Glutaraldehyde (25% glut is GA-25 and 50% glut is GA-50). [See table below]

In terms of actual biocide activity, it should be noted that the concentrations of the component in the products are as follows:

| | Active Biocide Component Released From |
|---|---|
| PRODUCT | a Product Dosage of 350 ppm |
| BACTRON KK-17 | 90 ppm |
| BACTRON KK-27 | 175 ppm |
| Champion 0-3670R | 70 ppm |

Test Conditions

Synthetic Seawater

| Chemical Component | mg/L |
|---|---|
| Chloride | 34,000 |
| Sulphate | 4,875 |
| Calcium | 600 |
| Magnesium | 2,333 |
| Barium | nil |
| Specific Gravity | 1.021 |
| pH | 6.2-7.0 |
| Total Hardness | 11,100 |
| Temperature | 25° C. |
| Flow Rate | 0.5-1.0 ft per second |

Additional nutrients were added to water to encourage bacteria growth.

In a series of tests, the planktonic SRB counts were compared for the biocides.

Experiments 1-3 represent results for planktonic bacteria.

Experiment 4 is a comparison of biocidal efficacy for planktonic and sessile bacteria. Viable SRB colonies are established on studs in a Robins device. The studs are removed, washed in sterile sea water and treated with solutions containing the test biocide. After exposures of 1, 3, 4, 8 or extended periods, coupons are rinsed, scraped and suspended in fresh synthetic sea water. Serial dilutions and ATP analyses are conducted on the samples to determine bacterial activity.

Results

| | Product | Active Biocide | | | |
|---|---|---|---|---|---|
| | Dosage | Component | | | |
| Product | (ppm) | Released (ppm) | 0 hr | 4 hr | 8 hr |
| Control 1 | | | >10⁴ | ≧10⁵ | ≧10⁵ |
| BACTRON | 100 | 50 | | 0 | 0 |
| KK-27 | | | | | |
| GA-50 | 100 | 50 | | 0 | 0 |
| Control 2 | | | ≧10⁵ | ≧10⁵ | ≧10⁵ |
| BACTRON | 100 | 50 | | 10-10² | ≧10² |
| KK-27 | | | | | |
| BACTRON | 250 | 125 | | 10 | 10-10² |
| KK-27 | | | | | |
| BACTRON | 500 | 250 | | 0 | 0 |
| KK-27 | | | | | |
| GA-50 | 100 | 50 | | 0 | 0 |
| Control 3 | | | ≧10⁵ | ≧10⁵ | ≧10⁵ |
| BACTRON | 100 | 25 | | ≧10² | ≧10² |
| KK-17 | | | | | |
| BACTRON | 500 | 125 | | ≧10² | 10 |
| KK-17 | | | | | |
| BACTRON | 100 | 50 | | 10-10² | 10 |
| KK-27 | | | | | |
| BACTRON | 500 | 250 | | 10-10² | 10 |
| KK-27 | | | | | |
| GA-25 | 100 | 25 | | 10-10² | 10 |
| GA-25 | 500 | 125 | | 0 | 0 |

| | | | 3 hr contact with biocide | |
|---|---|---|---|---|
| | | | Before | After |
| | | | Scraping | Scraping |
| Control 4, | | | ≧10⁸ | ≧10⁸ |
| planktonic | | | | |
| Control 4, | | | ≧10⁵ | ≧10⁵ |
| sessile | | | | |
| BACTRON | 200 | 100 | ≧10² | ≧10³ |
| KK-27 | | | | |
| GA-25 | 200 | 50 | 10-10² | ≧10² |
| GA-50 | 200 | 100 | 10 | 10 |

In evaluating the results for BACTRONs KK-17 and KK-27 note that the concentration of the active biocide component released from Champion O-3670R dosed at 350 ppm in the water is 70 ppm.

### CONCLUSION

These results confirm that glutaraldehyde is a more effective biocide than quaternary amines on sessile SRB colonies—if it can penetrate the glycocalyx. The two biocides in these tests are similar in their effects on planktonic organisms.

It must also be noted that glutaraldehyde and most oxygen scavengers are incompatible when mixed. In order to formulate a hydrotest inhibitor containing oxygen scavenger and a biocide, a quaternary amine biocide/corrosion inhibitor is normally the product of choice. In the stagnant conditions encountered in hydrostatic tests, quaternary amines are good corrosion inhibitors and provide more than adequate protection against SRB.

### SUMMARY

The above results demonstrate that Champion O-3670R when dosed at 350 ppm in sea water will provide sufficient oxygen scavenging, bacteria control and corrosion inhibition to ensure that a pipeline under hydrostatic testing/mothballing conditions is protected from the potential corrosion mechanisms.

1. A method for inhibiting corrosion of a pipeline, said method comprising applying a water-soluble corrosion inhibitor composition to the internal surface of a component segment of said pipeline before its assembly.

2. A method according to claim 1, wherein said water-soluble corrosion inhibitor composition is sprayed onto the internal surface of a component segment of said pipeline and dries as a hard coating.

3. A method according to claim 1 or claim 2, wherein the water-soluble corrosion inhibitor composition is applied to the pipeline as a coating of less than 1 mm thickness.

4. A method according to claim 1, wherein said water-soluble corrosion inhibitor composition is applied to said pipeline as a thixotropic gel.

5. A method according to claim 1, wherein said water-soluble corrosion inhibitor composition is applied to the pipeline as an amorphous gel.

6. A method according to claim 1, wherein said water-soluble corrosion inhibitor composition is spotted onto the interior surface of a component segment of the pipeline.

7. A method according to claim 1, wherein said water-soluble corrosion inhibitor composition is applied to the pipeline within a water-soluble bag that is attached to the internal wall of a pipeline.

8. A method according to claim 1, wherein said water-soluble corrosion inhibitor composition is applied to the interior surface of a pipeline at intervals of between 25 m and 200 m.

9. A method according to claim 1, wherein said water-soluble corrosion inhibitor composition comprises a corrosion inhibitor component and a binding agent component.

10. A method according to claim 9, wherein said binding agent component comprises a curing agent.

11. A method according to claim 9, wherein said binding agent component comprises a gelling agent.

12. A method according to claim 9, wherein said binding agent component comprises one or more of the following compounds: polyacrylamide, fish glue, highly-substituted hydroxypropyl guar (MS 1,2), monoethylene glycol.

13. A method according to claim 9, wherein said water-soluble corrosion inhibitor composition comprises around 90% binding agent and around 10% corrosion inhibitor component.

14. A method according to claim 12, wherein said binding agent component is polyacrylamide (250,000-1,000,000 Mw polymer).

15. A method according to claim 9, wherein said binding agent component contains fish glue and polyvinyl alcohol.

16. A method according to either of claims 9 or 12, wherein said binding agent component contains highly-substituted hydroxyproply guar (MS 1,2) and monoethylene glycol.

17. A method according to claim 9, wherein said water-soluble corrosion inhibitor composition additionally comprises a plasticiser.

18. A method according to claim 9, wherein said water-soluble corrosion inhibitor composition additionally comprises one or more biocide agents.

19. A method according to claim 18, wherein said biocide is one or more of the following compounds: a quaternary ammonium chloride, glutaraldehyde, formaldehyde, myacide, -alkyl dimethyl ammonia chloride, cocodiamine hydroxy acetate, tetrakis (hydroxymethyl) phosphonium sulphate and polymeric biguanide hydrochloride.

20. A method according to claim 9, wherein said corrosion inhibitor component comprises an oxygen scavenger, and a biocide.

21. A method according to claim 20, wherein said corrosion inhibitor component comprises product O-3670-R (Champion Technologies).

22. A method according to claim 20, wherein said oxygen scavenger is one or more of the following compounds: sodium bisulphite, ammonium bisulphite, hydrazine and sodium metabisulphite.

23. A method according to claim 9, wherein said water-soluble corrosion inhibitor composition additionally comprises one or more scale inhibitors, demulsifiers, anti-foaming agents, ax inhibitors or leak detection dyes.

24. A method according to claim 9, wherein said water-soluble corrosion inhibitor composition dissolves in static sea water at between 0.01 ppm/min and 100 ppm/min.

25. A method according to claim 1, wherein said pipeline is a subsea pipeline.

26. A pipeline comprising a corrosion inhibitor composition applied according to claim 1.

27. A pipeline according to claim 26, which is a subsea pipeline.
